(19) United States
(12) Patent Application Publication
(10) Pub. No.: US 2006/0089999 A1
(43) Pub. Date: Apr. 27, 2006

(54) Method for providing IMS-based wireless download services

(76) Inventors: Zeng-Jun Xiang, Vernon Hills, IL (US); Joon Young Park, Libertyville, IL (US); Aashu Virmani, North Andover, MA (US)

Correspondence Address: MOTOROLA, INC., 1303 EAST ALGONQUIN ROAD, IL01/3RD, SCHAUMBURG, IL, 60196, US

(21) Appl. No.: 11/254,212

(22) Filed: Oct. 19, 2005

Related U.S. Application Data
(60) Provisional application No. 60/621,564, filed on Oct. 22, 2004.

(51) Int. Cl. G06F 15/16

(52) U.S. Cl. 709/229

(57) ABSTRACT

Various embodiments are described to provide wireless download services that are more robust than those currently available. Signaling between and among the user equipment (UE) (101) obtaining download service, one or more IMS (IP multimedia subsystem) servers (151), and the download server (161) from which the content is obtained enable an improved level of service. Some improvements that may be realized include guaranteed QoS levels for content downloads, user selection of QoS (in real-time and per content request, possibly), flexible pricing options (e.g., per session, content-based, QoS-based billing), and authentication on a per-content basis.

### REFERENCE(S) TO RELATED APPLICATION(S)

The present application claims priority from provisional application, Ser. No. 60/621564, entitled “METHOD FOR PROVIDING IMS-BASED, WIRELESS DOWNLOAD SERVICES,” filed Oct. 22, 2004, which is commonly owned and incorporated herein by reference in its entirety.

### FIELD OF THE INVENTION

The present invention relates generally to wireless communications and, in particular, to providing IMS-based (IP multimedia subsystem) wireless download services.

### BACKGROUND OF THE INVENTION

At present, standards bodies such as OMA (Open Mobile Alliance), 3GPP (3rd Generation Partnership Project) and 3GPP2 (3rd Generation Partnership Project 2) are developing standards specifications for multimedia content delivery to wireless devices. (These groups may be contacted via http://www.openmobilealliance.com, http://www.3gpp.org/ and http://www.3gpp2.com/, respectively.) For example, IMS (IP multimedia subsystem) has been initially specified in 3GPP 23.228. However, as currently defined, IMS, and wireless content delivery in general, have some shortcomings.

For example, the present solutions lack sufficient control over download QoS (quality-of-service) for either the service user or the service provider. Also, the present charging (or billing) model is inflexible, usually forcing the service provider to charge based only on content size. Furthermore, authentication specific to content delivery is not supported. Rather, authentication is typically limited to the existing wireless network authentication procedures.

Accordingly, it would be desirable to have a method that provides improved wireless download services.

### BRIEF DESCRIPTION OF THE DRAWINGS

FIG. 1 is a block diagram depiction of a wireless communication system in accordance with multiple embodiments of the present invention.

FIG. 2 is an exemplary, high-level messaging flow diagram depicting user equipment (UE) obtaining IMS-based download service from a download server and an IMS server, in accordance with multiple embodiments of the present invention.

FIG. 3 is an exemplary messaging flow diagram depicting IMS server messaging to support an IMS-based download service for user equipment (UE), in accordance with multiple embodiments of the present invention.

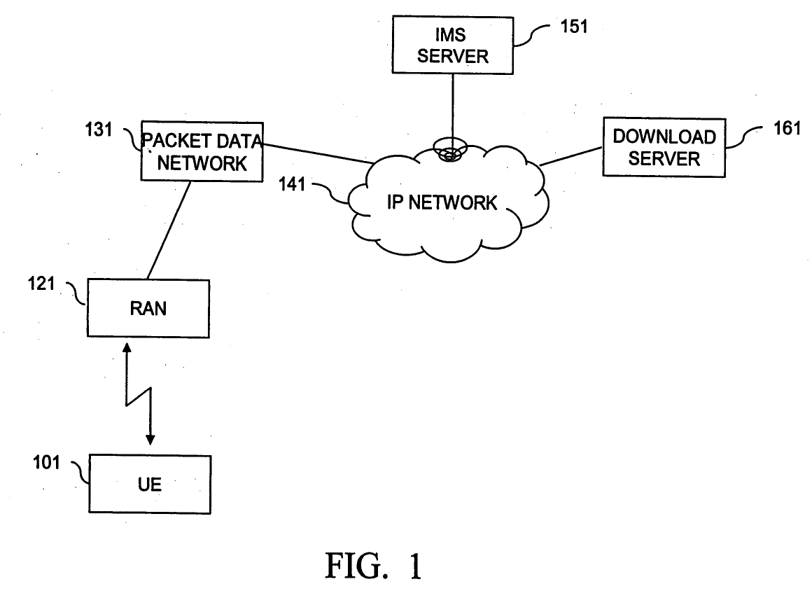

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to provide wireless download services that are more robust than those currently available. Signaling between and among the user equipment (UE) obtaining download service, one or more IMS (IP multimedia subsystem) servers, and the download server from which the content is obtained enable an improved level of service. Some improvements that may be realized include guaranteed QoS levels for content downloads, user selection of QoS (in real-time and per content request, possibly), flexible pricing options (e.g., per session, content-based, QoS-based billing), and authentication on a per-content basis.

The disclosed embodiments can be more fully understood with reference to FIGS. 1-3. FIG. 1 is a block diagram depiction of a wireless communication system 100 in accordance with multiple embodiments of the present invention. Communication system 100 represents a system having an architecture in accordance with one or more of the specifications described in the 3GPP standards (GSM, GPRS, EDGE, UMTS, etc.), suitably modified to implement the present invention. Alternative embodiments of the present invention may be implemented in communication systems that employ other (or additional) technologies such as, but not limited to, those specified in the 3GPP2 standards and the IEEE's 802.11, 802.16 and/or 802.20 specifications.

More specifically, communication system 100 comprises user equipment (UE) 101, radio access network (RAN) 121, packet data network 131, IP (internet protocol) network 141, IMS server 151 and download server 161. Those skilled in the art will recognize that FIG. 1 does not depict all of the network equipment necessary for system 100 to operate but only those system components and logical entities particularly relevant to the description of embodiments herein. For example, packet data networks are known to comprise devices such as Serving GPRS Support Nodes (SGSNs) and Gateway GPRS Support Nodes (GGSNs). Also, RANs are known to comprise devices such as base transceiver stations (BTSs), access points (APs), base site controllers (BSCs), and radio network controllers (RNCs), depending on which technology is employed.

User equipment is known to refer to a wide variety of consumer electronic platforms such as, but not limited to, mobile stations (MSs), access terminals (ATs), terminal equipment, gaming devices, personal computers, personal digital assistants (PDAs), cable set-top boxes and a satellite set-top boxes. IMS and download server platforms are also well-known. In general, download servers are content providers, perhaps operated by third parties, independent of the wireless communication network operator. Download servers may also perform content translation and distribution functions such as protocol translations and bearer encoding/decoding transformations.

Since UE and server platforms are well-known and given an algorithm, a logic flow, a messaging/signaling flow, a call flow, and/or a protocol specification, those skilled in the art are aware of the many design and development techniques available to implement a platform that performs the given logic. Furthermore, those skilled in the art will recognize that the download-server aspect, the IMS server aspect and the UE aspect of the present invention may each be implemented in and across various physical components and none are necessarily limited to single platform implementations.

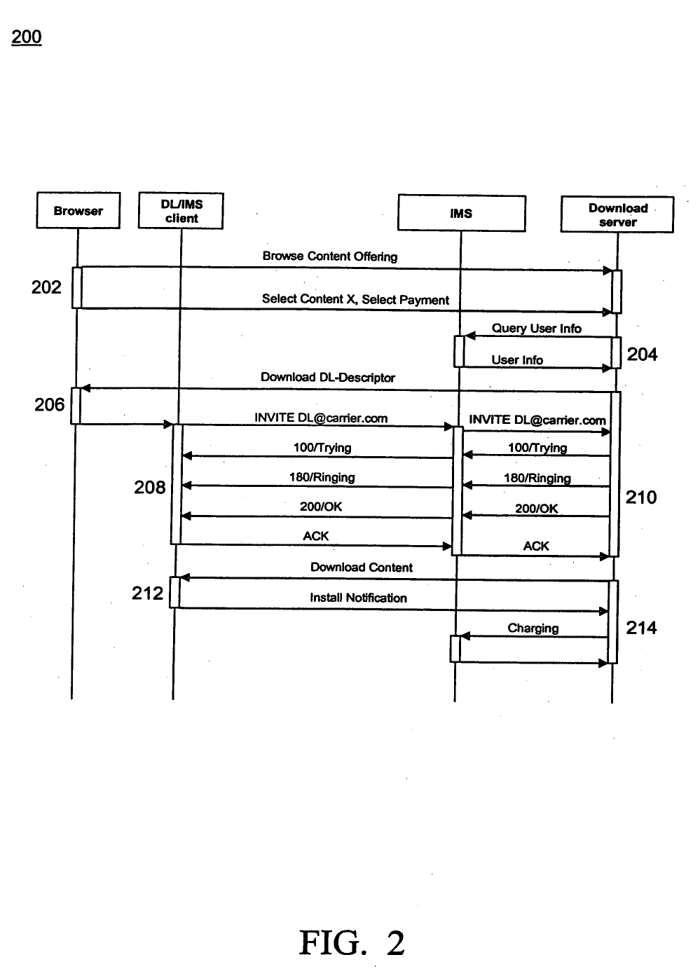

Relevant operation of various UE, IMS-server, and download-server embodiments will be described with reference to FIG. 2. FIG. 2 is an exemplary, high-level messaging flow diagram depicting UE obtaining IMS-based download service from a download server and an IMS server, in accordance with multiple embodiments of the present invention. This exemplary messaging flow illustrates procedures that enable a download service with guaranteed QoS, as provided by the IMS. It is assumed for the purposes of FIG. 2 that the download server, the IMS server, and the UE support the SIP protocol. Also particular to FIG. 2 are the browser and DL/IMS client entities that reside in the UE. These entities are merely exemplary and only applicable to some UE embodiments. More generally, the UE can be viewed as comprising a client that interfaces with the IMS server and the download server.

As depicted in FIG. 2, the browser initiates (see messaging 202) a browsing session with the download server. The UE user then selects specific content from the content offerings on the download server portal. In addition, the user may select a payment mode such as charge to my phone bill. The UE then sends to the download server a request for the selected content (see messaging 202) and indicates any payment mode selected by the user. Alternatively, however, the UE may neither browse nor request content, but rather the download server may initiate download messaging, such as with push data.

Receiving the request for content triggers the download server to send a request (see messaging 204) to the IMS server for download-related information associated with the UE. This information is maintained by the IMS server/HSS for the UE/user and includes subscription information such as authorization and accounting information. In response, the IMS server sends the download-related information for the UE to the download server.

The download server then uses the download-related information to generate a download descriptor for the UE. In some embodiments, this descriptor takes the form of an extended OMA Download Descriptor. For example, QoS extensions may be added to the current OMA Download Descriptor to provide flexible download options to the UE user. Such QoS extensions could be added to enable the UE user to select a download bandwidth, a bearer protocol for the content delivery, available content versions with different quality, and time when the content will be available. The bearer protocol options might include a push protocol, an on-demand delivery protocol, a broadcast protocol, a multicast protocol and/or streaming. For example, the UE user could be given the option to choose either a default download without any extra charges, a premium download with the applicable additional charges, or a premium download using DVB-H protocol with the applicable additional charges.

The QoS extensions described above may take the form of Session Descriptions. A Session Description is based on SDP (Session Description Protocol), which is intended for describing multimedia sessions for the purposes of session announcement, session invitation, and other forms of multimedia session initiation. The SDP simply provides a format for session description; it does not incorporate a transport protocol. To illustrate how an OMA Download Descriptor might be extended with one or more Session Descriptions, an example is provided below:

| | |
|---|---|
| 1 | <media xmlns=“http://www.openmobilealliance.org/xmlns/dd” |

| | |
|---|---|
| 2 | xmlns:sd=“http://www.openmobilealliance.org/xmlns/session-description”> |

| | |
|---|---|
| 3 | <type>image/gif</type> |
| 4 | <objectURI>http:/foo.bar.com/pic-dir/picture.gif</objectURI> |
| 5 | <size>1234</size> |
| 6 | <installNotify-URI>http:/foo.bar.com/status</installNotify-URI> |
| 7 | <sd:sessions> |
| 8 | <sd:session> |

| | |
|---|---|
| 9 | <sd:type>application/sdp</sd:type> |
| 10 | <sd:description> |

| | |
|---|---|
| 11 | i=54Kbps download session, default subscription |
| 12 | u=http://foo.bar.com/pic-dir/picture.gif |

| | |
|---|---|
| 13 | </sd:description> |

| | |
|---|---|
| 14 | </sd:session> |
| 15 | <sd:session> |

| | |
|---|---|
| 16 | <sd:type>application/sdp</sd:type> |
| 17 | <sd:description> |

| | |
|---|---|
| 18 | i=128Kbps download session, 0.5 USD additional charge |
| 19 | u=http://192.168.2.55/pic-dir/picture.gif |

| | |
|---|---|
| 20 | </sd:description> |

| | |
|---|---|
| 21 | </sd:session> |
| 22 | <sd:session> |

| | |
|---|---|
| 23 | <sd:type>application/sdp</sd:type> |
| 24 | <sd:description> |

| | |
|---|---|
| 25 | i=1Mbps, DVB-H |
| 26 | u=http://192.168.2.55/pic-dir/picture.gif |
| 27 | v=0 |
| 28 | o=user 2890844526 2890842807 IN IP4 10.20.30.40 |
| 29 | s=File delivery session example |
| 30 | t=2873397496 2873404696 |
| 31 | a=source-filter: incl IN IP4 * 10.20.30.40 |
| 32 | a=flute-tsi:1 |
| 33 | a=flute-ch:1 |
| 34 | m=application 4001 FLUTE 0 |
| 35 | c=IN IP4 226.10.40.1/15 |

| | |
|---|---|
| 36 | </sd:description> |

| | |
|---|---|
| 37 | </sd:session> |

| | |
|---|---|
| 38 | </sd:sessions> |

| | |
|---|---|
| 39 | </media> |

Line numbers 8 to 14 above show a Download Session Description for which the service provider does not charge anything for the corresponding Media Object download. The service provider may only charge for the Media Object itself or the Rights Object which govern the consumption of the Media Object.

Line numbers 15 to 21 show a Download Session Description for which the service provider will guarantee 128 Kbps download bandwidth but charge 50 cents for the Media Object download. In some case, in order to provide the download bandwidth, the service provider may relocate the Media Object onto a server (192.168.2.55) which is geographically closer to the UE. Therefore, the total charge for the Media Object download will be 50 cents plus any charge for content itself.

Line numbers 22 to 38 show a Download Session Description for which the service provider will use broadcast bearer for the Media Object delivery. Once the UE chooses to download using this session, then the UE is joined to the broadcast session and constructs the whole Media Object by gathering individual UDP packets. In general, using Session Description as described above can enable the use of download mechanisms in addition to on-demand downloads (like HTTP, e.g.), much faster downloads when broadcast bearer is selected (1 Mbps with DVB-H, e.g.), scheduled downloads (the start and end times of broadcasts can be scheduled, e.g.), and improved resource reservation/allocation.

Referring again to FIG. 2, the download server sends (see messaging 206) the download descriptor, based on the download-related information, to the UE. The download descriptor, examples of which were discussed in detail above, indicates one or more QoS options for the UE/user for the download. In response to this download descriptor, the UE sends a download request that indicates its selected QoS option.

In some embodiments, the UE initiates a signaling session using the QoS extension selected from the download descriptor. In these embodiments, the Session Initiation Protocol (SIP) may be used by the UE, the IMS server, and the download server. SIP is a text-based protocol, similar to HTTP and SMTP, for initiating interactive communication sessions. The Internet Engineering Task Force (IETF) may be contacted for a more complete description of SIP. Hence, the download request that the UE sends may take the form of a SIP INVITE message (see messaging 206).

The IMS server receives the download request (see messaging 208) indicating the selected QoS option and sends an indication of the download request and QoS option on to the download server. The download server coordinates with the IMS server to provide the download to the UE with the QoS download option selected. The IMS server facilitates support for the download by obtaining the appropriate network resource reservations to provide at least the QoS level selected. Thus, the UE is able to receive the download at the speed, time, price, and manner selected.

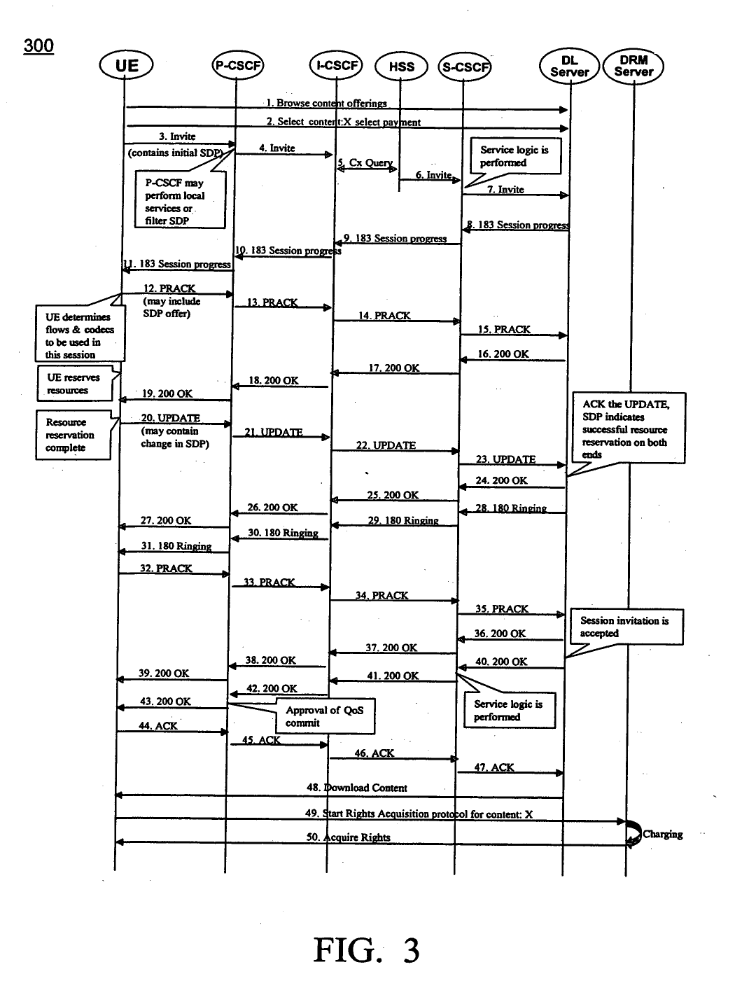

For the embodiments in which SIP is used, messaging 208 and 210 depict some of the additional SIP messaging between the UE, the IMS server and the download server to coordinate the download and selected QoS option. However, FIG. 3 provides a more detailed example of such SIP messaging. FIG. 3 in fact also depicts intra-IMS messaging. The P-CSCF (proxy core session control function), the I-CSCF (interrogate core session control function), the HSS (home subscriber server) and the S-CSCF (serving core session control function) are all IMS functional entities presently defined in the 3GPP specification. Moreover, in addition to the download (DL) server a digital rights management (DRM) server is also depicted.

As depicted in FIG. 2, for some embodiments, messaging 208 and 210 depict a SIP messaging session involving the UE, the IMS server, and the download server, while messaging 212 depicts a content download session between the download server and the UE. Again for some embodiments, the download server authenticates the UE before downloading content to the UE. This authentication may be performed by sending the UE a download session access key and receiving in response the download session access key signed by a private key of the UE. In embodiments where two physically different sessions are used, the download server can send the download session access key to the IMS server for delivery to the UE, such as in a SIP OK message. Here, the download session access key may be encrypted using the UE's (or IMS client's) public key and the SIP body, which includes the download session, may be signed using the download server's private key. Also, if the UE uses on-demand communication, such as HTTP, to download the media object, the HTTP request has to include the download session access key which may be signed using the UE's (or IMS client's) private key.

In addition to authentication, the download server may also prepare the download content for delivery. There may be some content transcription required for the target UE or according to the UE's QoS option selection. The download server may also transfer the content to another server which is, for example, closer to the subscriber geographically for improved downloading. Again, depending on the QoS selection and/or service subscription the content may be pushed, delivered on-demand (e.g., by HTTP), or broadcast. Once the download is complete, the UE may report back to the download server with a download status indication (see messaging 212) for the content delivery. Such a status indication or delivery notification is optional since certain bearer protocols guarantee delivery. Also, based on the status of the content delivery, the download server may send billing-related information (see messaging 214) for the download, such as a charging record, to the IMS server for processing.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for providing IMS-based (IP multimedia subsystem), wireless download services, the method comprising:
sending, by a download server to an IMS server, a request for download-related information associated with particular user equipment (UE);
receiving, by the download server from the IMS server, the download-related information in response to the request;
sending, by the download server to the UE, a download descriptor that is based on the download-related information and that indicates at least one quality of service (QoS) option for a download;
receiving, by the download server from the UE via the IMS server, a download request that indicates a selected QoS option from the at least one QoS option indicated in the download descriptor; and
coordinating, by the download server with the IMS server, a download to the UE that has a QoS level of at least that indicated by the selected QoS option.

2. The method of claim 1, further comprising receiving, by the download server from the particular UE, a request for content that triggers the download server to send the request to the IMS server for download-related information associated with the UE.

3. The method of claim 2, wherein the request for content indicates a payment mode to be used for the content.

4. The method of claim 1, wherein the download-related information associated with the UE comprises information from the group consisting of subscription type and authorization and accounting information.

5. The method of claim 1, wherein the at least one QoS option comprises QoS options from the group consisting of download bandwidth, bearer protocol for content delivery, available content versions with different quality, and time when the content will be available.

6. The method of claim 1, wherein the bearer protocol for content delivery comprises a protocol from the group consisting of a push protocol, an on-demand delivery protocol, a broadcast protocol, a multicast protocol and streaming.

7. The method of claim 1, wherein the download request comprises a Session Initiation Protocol (SIP) INVITE message.

8. The method of claim 1, wherein coordinating the download with the IMS server comprises coordinating the download using a Session Initiation Protocol (SIP) session with the IMS server and the UE and a content download session between the download server and the UE.

9. The method of claim 1, wherein coordinating the download with the IMS server comprises authenticating the UE before downloading content to the UE.

10. The method of claim 9, wherein authenticating the UE comprises:
sending a download session access key to the IMS server for delivery to the UE; and
receiving the download session access key signed by a private key of the UE.

11. The method of claim 1, wherein coordinating the download with the IMS server comprises joining the UE to a broadcast session when the download request indicates a broadcast option.

12. The method of claim 1, further comprising receiving, by the download server from the UE, a download status indication.

13. The method of claim 1, further comprising sending, by the download server to the IMS server, billing-related information for the download.

14. A method for providing IMS-based (IP multimedia subsystem), wireless download services, the method comprising:
receiving, by an IMS server from a download server, a request for download-related information associated with particular user equipment (UE);
sending, by the IMS server to the download server, the download-related information in response to the request;
receiving, by the IMS server from the UE, a download request that indicates a selected QoS option from at least one QoS option indicated in a download descriptor;
sending, by the IMS server to the download server, an indication of the download request from the UE; and
facilitating, by the IMS server for the download server, a download to the UE that has a QoS level of at least that indicated by the selected QoS option.

15. The method of claim 14, wherein facilitating the download for the download server comprises conducting a second Session Initiation Protocol (SIP) session with the UE based on a first SIP session between the IMS server and the download server.

16. The method of claim 14, further comprising receiving, by the IMS server from the download server, billing-related information for the download.

17. A method for providing IMS-based (IP multimedia subsystem), wireless download services, the method comprising:
receiving, by user equipment (UE) from a download server, a download descriptor that indicates at least one quality of service (QoS) option for a download;
sending, by the UE to the download server via the IMS server, a download request that indicates a selected QoS option from the at least one QoS option indicated in the download descriptor; and
receiving, by the UE, a download that has a QoS level of at least that indicated by the selected QoS option.

18. The method of claim 17, further comprising sending, by the UE to the download server, a request for content.

19. The method of claim 17, wherein the UE comprises equipment form the group consisting of a mobile station, an access terminal, terminal equipment, a gaming device, a personal computer, a personal digital assistant, a cable set-top box and a satellite set-top box.
